(19) United States
(12) Patent Application Publication
(10) Pub. No.: US 2025/0050916 A1
(43) Pub. Date: Feb. 13, 2025

(54) METHOD FOR OPERATING A VEHICLE, COMPUTER PROGRAM, CONTROL SYSTEM AND VEHICLE

(71) Applicant: VALEO SCHALTER UND SENSOREN GMBH, Bietigheim-Bissingen (DE)

(72) Inventors: Ashwin-Dayal George, Bietigheim-Bissingen (DE); Ashraf Nabil, Cairo (EG)

(73) Assignee: VALEO SCHALTER UND SENSOREN GMBH, Bietigheim-Bissingen (DE)

(21) Appl. No.: 18/720,135

(22) PCT Filed: Dec. 8, 2022
(86) PCT No.: PCT/EP2022/084900

§ 371 Date: Jun. 14, 2024

(30) Foreign Application Priority Data
Dec. 14, 2021 (DE) 10 2021 132 924.8

(51) Int. Cl. B60W 60/00; B60W 30/14; B60W 50/10; B60W 50/14

(52) U.S. Cl. CPC B60W 60/0055; B60W 30/143; B60W 50/10; B60W 50/14; B60W 60/001; B60W 2520/10; B60W 2552/53; B60W 2554/4042; B60W 2554/801; B60W 2554/802

(57) ABSTRACT

A method for operating an ego-vehicle includes receiving sensor data of a sensor system of the ego-vehicle, detecting an absence of lane markings based on the sensor data, and transmitting instructions to a human machine interface of the ego-vehicle to prompt a driver of the ego-vehicle to drive to a perceived center line of a lane. The method also includes determining a virtual lane based on the perceived center line to which the driver has driven, and performing a lane keeping assistant function to keep the ego-vehicle on the virtual lane.

The present invention relates to a method for operating a vehicle, a computer program, a control system and a vehicle with such a control system.

Modern vehicles, such as passenger vehicles, are nowadays usually equipped with several driver assistant systems. An example is a lane keeping system which detects a lane of a road on which a vehicle is driving based on sensor data and positions the vehicle within the delineations of the lane. Lane keeping systems rely primarily on the detection of lane markings on the road. A problem occurs if no lane markings are present on the road. US 2019 382 008 A1 proposes a method for lane keeping in cases where no lane markings are detected based on an extrapolation of the last detected lane markings.

It is one object of the present invention to provide an improved method for operating a vehicle.

Accordingly, a method for operating a vehicle is provided. The method comprises the steps:
a) receiving sensor data of a sensor system of the vehicle,
b) detecting an absence of lane markings based on the sensor data,
c) transmitting instructions to a human machine interface of the vehicle to prompt a driver of the vehicle to drive to a perceived center line of a lane,
d) determining a virtual lane based on the perceived center line to which the driver has driven, and
e) performing a lane keeping assistant function to keep the vehicle on the virtual lane.

In cases in which no lane markings are detected in the sensor data, the driver might be in a better position to perceive and understand the overall scenario. Thus, by prompting the driver to drive the vehicle to a perceived center line of a lane and using the position to which the driver has driven the vehicle as input for determining a virtual lane, a lane keeping assistant function can be provided also in cases in which no lane markings are detected in the sensor data. Hence, a control system of the vehicle (e.g., a lane keeping system) receives feedback from the driver regarding the location of the correct lane and can learn from this feedback.

For example, on a highway with two or more lanes on which left and right delineations of the highway are visible due to the presence of left and right crash barriers but no lane markings are available, the lane keeping system may be able to determine a curvature of a lane based on detecting the crash barriers but may not be able to determine a lateral position of a lane on which the vehicle is driving or should be driven. Here, it may be easier for the driver to perceive a correct lateral position of a lane.

The method steps are, in particular, carried out by a control system of the vehicle. The control system is, for example, outputting an instruction to a steering system of the vehicle in accordance with the determined virtual lane. The instruction is, for example, an instruction to steer towards a center line of the virtual lane.

The sensor system of the vehicle (ego-vehicle) is, in particular, an environmental sensor system comprising one or more environmental sensor units. The sensor units are configured to detect a driving state of the vehicle and an environment of the vehicle. Examples of such sensor units are a camera device for capturing images of the surrounding, a radar device (radio detection and ranging) for obtaining radar data and a lidar device (light detection and ranging) for obtaining lidar data. The sensor system may in addition include ultrasonic sensors, location sensors, wheel angle sensors and/or wheel speed sensors. The sensor units are each configured to output a sensor signal, for example to a driving assistance system or a parking assistance system, which for example performs assisted or (semi-)autonomous driving as a function of the detected sensor signals. In particular, the sensor units can each be configured to output a sensor signal to a control system and/or a lane keeping system of the vehicle, which performs automatic lane keeping control as a function of the detected sensor signals.

For example, the presence or absence of lane markings of a road may be detected based on images (as an example of sensor data) of a camera device of the vehicle. The camera device is, for example, a front camera arranged at the front windscreen of the vehicle and configured to monitor an area in front of the vehicle. However, the camera device may also be arranged at a different window of the vehicle and/or monitor a different area, e.g., at the sides and/or behind the vehicle.

The human machine interface (HMI) of the vehicle includes, for example, one or more displays, one or more touch panels, one or more keyboards, one or more buttons, one or more (rotary) knobs, one or more loudspeaker, one or more microphones and/or one or more driver monitoring cameras.

The perceived center line to which the driver has driven the vehicle can, for example, be used as a starting position and/or direction for determining the virtual lane. The perceived center line to which the driver has driven the vehicle can, for example, be used as one of several inputs used for determining the virtual lane.

The vehicle is, for example, a passenger car, a van or a truck. The vehicle is, for example, configured for assisted, semi-autonomous and/or fully autonomous driving. A level of automatization of the vehicle is, for example, any of a level 1 or 2 (hands-on system) to a level 5 (fully automatic). Said levels 1 to 5 correspond to the SAE classification system published in 2014 from SAE International as J3016 (“Taxonomy and Definitions for Terms Related to On-Road Motor Vehicle Automated Driving Systems”).

Determining the virtual lane includes, for example, determining a center line and a lane width of the virtual lane. The center line starts, for example, at a front end (e.g., a front bumper) of the vehicle (ego-vehicle). In case that a preceding target vehicle is detected, the center line may, for example, extend at least to a back end (e.g., a back bumper) of the preceding target vehicle.

In embodiments, in step d) of the method, the virtual lane is determined based on—in addition to the perceived center line to which the driver has driven—one or more object(s) in the vicinity of the vehicle (ego-vehicle). In this case, the method may comprise a step of detecting the one or more objects in the vicinity of the vehicle based on the sensor data. The method may further comprise a step of determining positional information of the one or more objects based on the sensor data. Furthermore, the virtual lane may be determined based on—in addition to the perceived center line to which the driver has driven—the positional information of the one or more objects in the vicinity of the vehicle.

According to an embodiment, the method comprises the step of detecting a presence of one or more other vehicles in a region of interest based on the sensor data, wherein the virtual lane is determined based on positional information of the one or more other vehicles with respect to the ego-vehicle, the positional information being determined based on the sensor data.

In addition to the driver's perceived center line, determining the virtual lane based also on positional information of detected other vehicles in the region of interest can result in better virtual lane estimation.

The method includes, in particular, the step of determining the positional information (positional data) of the one or more other vehicles based on the sensor data. The positional information of the one or more other vehicles are, for example, determined relative to the position of the ego-vehicle.

The positional information of a respective other vehicle includes, for example, a lateral distance between the respective vehicle and the ego-vehicle and/or a direction of travel (e.g., heading angle) of the respective vehicle with respect to the ego-vehicle. The lateral distance is, for example, a lateral distance between a central lateral position of a respective other vehicle and a central lateral position of the ego-vehicle (this applies, in particular, in the case of a preceding target vehicle). Alternatively, the lateral distance is, for example, a lateral distance of a space between a respective other vehicle and the ego-vehicle (this applies, in particular, in the case of a left/right target vehicle). The heading angle is, in particular, an angle of a current travel direction of the respective vehicle with respect to a heading angle of the current travel direction of the ego-vehicle. The positional information of a respective other vehicle includes, for example, a trajectory of the respective vehicle.

The region of interest is, for example, a region ahead of the ego-vehicle. A width of the region of interest includes, for example, a width of the road on which the ego-vehicle is driving. A width of the region of interest is, for example, 12 meters or smaller, 10 meters or smaller, 8 meters or smaller and/or 6 meters or smaller. A length of the region of interest is, for example, 100 meters or smaller, 90 meters or smaller, 80 meters or smaller and/or 70 meters or smaller.

The lane keeping assistant function is, for example, performed such that the virtual lane is repeatedly determined based on repeatedly updated positional information of the identified target vehicles (i.e., a preceding target vehicle, a left target vehicle and/or a right target vehicle) to keep the ego-vehicle on the repeatedly updated virtual lane.

By using more than one target vehicle for determining the virtual lane, the virtual lane can be better estimated and depends less on the movement of a single other vehicle.

According to a further embodiment, the method comprises the steps of:
f) determining, after the driver has driven to the perceived center line, a driving channel of the ego-vehicle based on the sensor data, wherein a length of the driving channel corresponds to a driving distance of the ego-vehicle in a predetermined time span, a width of the driving channel corresponds to a predetermined vehicle width, and the region of interest includes the driving region at least partly,
g) determining a percentage of an overlap between the determined driving channel and a vehicle detected in the region of interest and preceding the ego-vehicle,
h) determining that the preceding vehicle is driving on the same lane as the ego-vehicle and is a preceding target vehicle when the determined percentage of the overlap is above a predetermined value, and
i) determining the virtual lane based on the positional information of the preceding target vehicle.

By determining the driving channel of the ego-vehicle and checking if other vehicles in the region of interest are (partly) overlapping the driving channel, it is possible to identify a vehicle in the region of interest as being a preceding vehicle on the same lane as the ego-vehicle. In particular, an overlap by a percentage above the predetermined value indicates a suitability of the preceding vehicle as target vehicle for determining the virtual lane.

The driving channel describes, in particular, the current path of the ego-vehicle after the driver has steered to the perceived lane center.

The driving channel is, in particular, a two-dimensional region (e.g., defined by its width and length). The driving channel is, in particular, a two-dimensional geometrical region arranged parallel to a plane of a road on which the vehicle is driving.

The overlap between the determined driving channel and the respective vehicle is, for example, an overlap of a region occupied by the preceding vehicle and a region of the driving channel. The region occupied by the preceding vehicle is, in particular, a two-dimensional region. The region occupied by the preceding vehicle is, in particular, arranged in the same plane as the driving channel.

The overlap between the determined driving channel and the respective vehicle is, for example, an overlap in a lateral direction.

Determining the driving channel after the driver has driven to the perceived center line may include determining the driving channel after the driver has confirmed that s/he has driven to the perceived center line.

The width of the driving channel corresponding to a predetermined vehicle width corresponds, for example, to a width of the ego-vehicle.

The predetermined value of step h) is for example, 20%, 30%, 40%, 50% or 60%.

According to a further embodiment,
when it is determined that the percentage of the overlap is equal to or below the predetermined value and above a further predetermined value, step c) and steps g) to i) are repeated, the further predetermined value being smaller than the predetermined value, and
when it is determined that the percentage of the overlap is equal to or below the further predetermined value, it is determined that the preceding vehicle is unsuitable for determining the virtual lane.

In the case that the percentage of the overlap between the determined driving channel and the vehicle detected in the region of interest and preceding the ego-vehicle is equal to or below the predetermined value, the overlap is too small for assuming that the other vehicle is driving on the same lane. In this case, by repeating step c), the driver is prompted to reposition the vehicle by driving (again) to the perceived center line of the lane. Then, the percentage of the overlap is determined again.

The further predetermined value is, for example, larger than zero and/or 1%, 5%, 10%, 15% or 20%.

In embodiments, when it is determined that the preceding vehicle is unsuitable for determining the virtual lane and/or no preceding vehicle is present, but the driver has still driven to a perceived centerline, the virtual lane may be determined based on one or more other vehicles on the left and/or right side of the vehicle (ego-vehicle).

According to a further embodiment, the method comprises the steps of:
determining a lateral distance between each of the one or more other vehicles detected in the region of interest and the ego-vehicle based on the sensor data, the lateral distance including a left lateral distance with respect to a left side of the ego-vehicle and a right lateral distance with respect to a right side of the ego-vehicle,
determining that a respective other vehicle is driving on a left neighboring lane with respect to the ego-vehicle and is a left target vehicle, when the determined left lateral distance thereof is above a predetermined threshold, and determining that a respective other vehicle is driving on a right neighboring lane with respect to the ego-vehicle and is a right target vehicle, when the determined right lateral distance thereof is above the predetermined threshold, and
determining the virtual lane based on the positional information of the left and/or right target vehicles on the left and/or right neighboring lanes.

Thus, it is investigated if one or more of the other vehicles detected in the region of interest are driving on a left or right neighboring lane with respect to the ego-vehicle. In particular, a suitability of each of the other vehicles as further target vehicles (i.e., left target vehicle or right target vehicle) for lane keeping is analyzed.

The predetermined threshold is, for example, larger than half of the width of the driving channel. In other words, the predetermined threshold is set such that only vehicles outside of the driving channel of the ego-vehicle are determined as vehicles on a left or right neighboring lane.

By determining the virtual lane based on the positional information of the left and/or right target vehicles, the lane keeping function of the ego-vehicle can be performed such that the ego-vehicle is maintaining a lateral safety distance to the left and/or right target vehicles. If both a left and right target vehicle are present, the lane keeping function of the ego-vehicle can be performed such that the ego-vehicle is driving laterally (in the middle or not in the middle) between the left and right target vehicles.

According to a further embodiment, determining the virtual lane includes determining a left delineation of the virtual lane based on the positional information of the left target vehicle and/or determining a right delineation of the virtual lane based on the positional information of the right target vehicle.

For example, the left delineation of the virtual lane is determined such that a distance between the driving channel and the left delineation is larger than a predetermined lateral safety threshold. Further, the right delineation of the virtual lane is determined such that a distance between the driving channel and the right delineation is larger than the predetermined lateral safety threshold.

According to a further embodiment, a center line of the virtual lane is determined based on a first preliminary center line and/or a second preliminary center line, the first preliminary center line being derived based on a detected preceding target vehicle and the second preliminary center line being derived based on detected left and/or right target vehicles.

Thus, the virtual lane is determined based on positional information of both a preceding vehicle on the same lane as the ego-vehicle and one or more left and/or right target vehicles on neighboring lanes.

According to a further embodiment, the center line of the virtual lane is determined based on a mean and/or weighted mean value of the first preliminary center line and the second preliminary center line.

The center line of the virtual lane is, for example, determined based on a mean and/or weighted mean value of a heading angle of the preceding target vehicle and a heading angle of each of the one or more left and/or right target vehicles.

The center line of the virtual lane is, for example, determined by taking into account a lateral position of the preceding target vehicle and a lateral position of each of the one or more left and/or right target vehicles, the lateral positions being lateral positions with respect to the ego-vehicle.

The virtual lane is, for example, determined based on a mean and/or weighted mean trajectory of the trajectories of the preceding target vehicle and each of the one or more left and/or right target vehicles.

According to a further embodiment,
when a preceding target vehicle is detected, the first preliminary center line of the virtual lane is determined based on a lateral distance between the preceding target vehicle and the ego-vehicle,
when a left target vehicle and a right target vehicle are detected, the second preliminary center line of the virtual lane is determined such that a lateral distance between the second preliminary center line and the left target vehicle equals a lateral distance between the second preliminary center line and the right target vehicle, and/or
when a left target vehicle and/or a right target vehicle are detected, the second preliminary center line of the virtual lane is determined such that a lateral distance between the ego-vehicle and the left target vehicle is above a predetermined safety distance and/or such that a lateral distance between the ego-vehicle and the right target vehicle is above the predetermined safety distance.

According to a further embodiment,
a lane width of the virtual lane is determined such that it equals a sum of the predetermined vehicle width, a left offset value and a right offset value, and
the left offset value is determined based on the determined lateral distance between the ego-vehicle and the left target vehicle, or
the left offset value is set equal to a predetermined value, and/or
the right offset value is determined based on the determined lateral distance between the ego-vehicle and the right target vehicle, or
the right offset value is set equal to a predetermined value.

For example, if a left target vehicle is detected, the left offset value is determined based on the determined lateral distance between the ego-vehicle and the left target vehicle. If no left target vehicle is detected, the left offset value is set equal to the predetermined value. The same applies, mutatis mutandis, to the right target vehicle.

According to a further embodiment, step c) includes:
transmitting instructions to the human machine interface to output a question to the driver if the driver is willing to drive to a perceived center line of a lane,
receiving an information of the human machine interface corresponding to an answer of the driver, and
transmitting, when the received information corresponds to a positive answer, instructions to the human machine interface to prompt the driver to confirm that the driver has driven to the perceived center line of the lane.

Thus, only when the driver has confirmed that the current position of the vehicle corresponds to the perceived center line of the lane, the virtual lane is determined based on this position.

According to a further embodiment, the method comprises the steps of:
performing an adaptive cruise control based on a detected preceding target vehicle such that a longitudinal distance between the ego-vehicle and the preceding target vehicle is controlled to have a predetermined distance value, and/or
performing a cruise control based on detected left and/or right target vehicles such that a speed of the ego-vehicle is controlled based on a speed of the left and/or right target vehicles.

According to a second aspect, a computer program is provided. The computer program comprises instructions which, when the program is executed by a computer, cause the computer to carry out the above-described method.

A computer program (computer program product), such as a computer program means, may be embodied as a memory card, USB stick, CD-ROM, DVD or as a file which may be downloaded from a server in a network. For example, such a file may be provided by transferring the file comprising the computer program product from a wireless communication network.

According to a third aspect, a control system for a vehicle is provided. The control system is configured to perform the above-described method.

The control system is, for example, a lane keeping system or is part of a lane keeping system.

According to a fourth aspect, a vehicle with an above-described control system is provided.

The respective above or below described entities, e.g., the control system, a receiving unit, a detecting unit, a communication unit, a determining unit, a lane keeping unit, an output unit, may be implemented in hardware and/or in software. If said entity is implemented in hardware, it may be embodied as a device, e.g. as a computer or as a processor or as a part of a system, e.g. a computer system. If said entity is implemented in software it may be embodied as a computer program product, as a function, as a routine, as an algorithm, as a program code, part of a program code or as an executable object. Furthermore, each of the entities mentioned above can also be designed as part of a higher-level control system of the vehicle, such as a central electronic control unit (ECU).

The embodiments and features described with reference to the method of the present invention apply, mutatis mutandis, to the computer program, the control system and the vehicle of the present invention.

Further possible implementations or alternative solutions of the invention also encompass combinations—that are not explicitly mentioned herein—of features described above or below with regard to the embodiments. The person skilled in the art may also add individual or isolated aspects and features to the most basic form of the invention.

Further embodiments, features and advantages of the present invention will become apparent from the subsequent description and dependent claims.

In the following, the invention will be described in detail based on preferred embodiments with reference to the following figures.

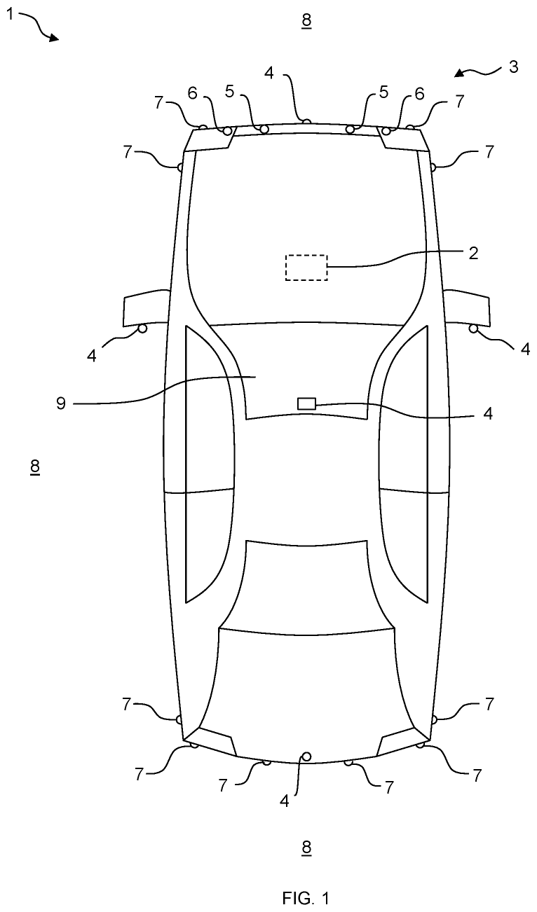

FIG. 1 shows a top view of a vehicle according to an embodiment;

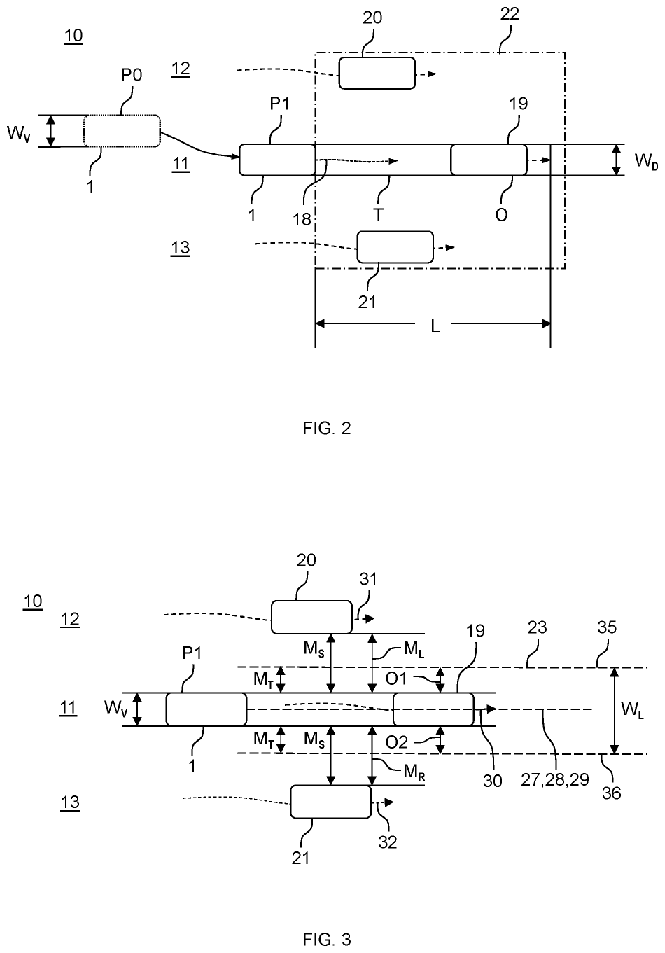

FIG. 2 shows the vehicle of FIG. 1 and other vehicles on a road;

FIG. 3 shows a view similar as FIG. 2 with an illustration of a determined virtual lane;

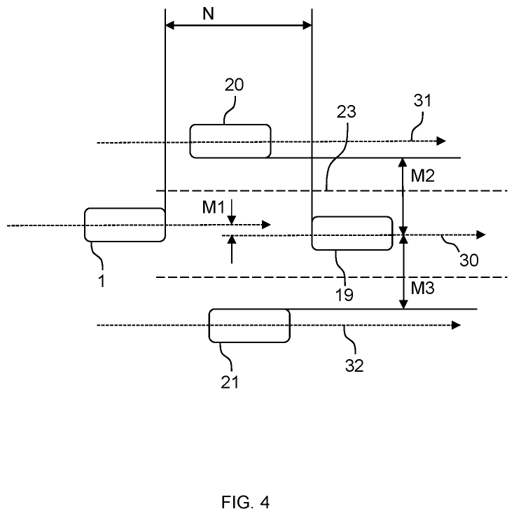

FIG. 4 shows a view similar as FIG. 3 with a different arrangement of the vehicles;

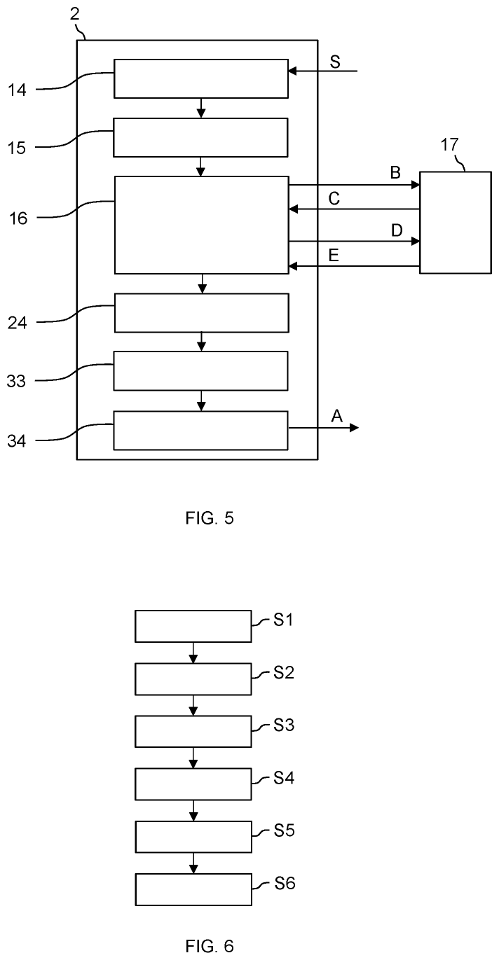

FIG. 5 shows a control system of the vehicle of FIG. 1; and

FIG. 6 shows a flowchart illustrating a method for operating the vehicle of FIG. 1.

In the figures, like reference numerals designate like or functionally equivalent elements, unless otherwise indicated.

FIG. 1 shows a schematic top view of a vehicle 1. The vehicle 1 is, for example, a passenger vehicle. The vehicle 1 may also be another kind of vehicle such as a van or truck. The vehicle 1 comprises a control system 2 for controlling the vehicle 1. The control system 2 is, in particular, a lane keeping system.

The vehicle 1 further comprises an electronically controllable steering system (not shown). The control system 2 is configured to transmit instructions A (FIG. 5) to the steering system for lane keeping purposes.

As shown in FIG. 1, the vehicle 1 comprises a sensor system 3 including several environmental sensor units 4, 5, 6, 7 arranged at the vehicle 1. The sensor system 3 comprise, in particular, one or more camera devices 4 such as one or more front camera devices. The camera devices 4 are configured for obtaining image data of a surrounding 8 of the vehicle 1 and for transmitting the image data or results of an image analysis of the image data to the control unit 2. The front camera device 4 is attached to a front windscreen 9 of the vehicle 1.

The sensor system 3 further comprise, for example, one or more radar devices 5 for obtaining radar data of the surrounding 8 of the vehicle 1. The sensor system 3 may further comprise, for example, one or more lidar devices 6 for obtaining lidar data of the surrounding 8 of the vehicle 1.

The sensor system 3 may comprise further sensors such as ultrasonic sensors 7, rain sensors, light sensors, wheel sensors and/or wheel speed sensors (not shown).

In the following, a method for operating the vehicle 1 will be described with reference to FIGS. 2 to 6. The method is, in particular, a method for performing a lane keeping assistant function.

FIG. 2 shows the vehicle 1 of FIG. 1 on a road 10. The road 10 comprises three lanes 11, 12, 13 but there are no lane markings on the road 10. Hence, a lane keeping function based on detected lane markings cannot be performed by the lane keeping system (control system 2). In FIG. 2, the vehicle 1 (ego-vehicle 1) is shown on two different positions P0 and P1.

In a first step S1 of the method, the control system 2 of the vehicle 1 receives sensor data S (FIG. 5) of the sensor system 3 (FIG. 1) of the vehicle 1. The sensor data S comprise, in particular, data from a camera device 4 (FIG. 1) of the vehicle 1. The sensor data S may also comprise, for example, data from a radar device 5 and/or data from a lidar device 6 of the vehicle 1. The control system 2 comprises, for example, a receiving unit 14 (FIG. 5) for receiving the sensor data S from the sensor system 3.

In a second step S2 of the method, the control system 2 detects an absence of lane markings on the road 10 based on the sensor data S. The control system 2 comprises, for example, a detecting unit 15 (FIG. 5) for detecting the absence of lane markings based on the sensor data S.

In a third step S3 of the method, the control system 2 transmits instructions B to a human machine interface 17 (HMI-unit 17, FIG. 5) of the vehicle 1 to prompt a driver of the vehicle 1 to drive to a perceived center line 18 of a lane 11 (FIG. 2). The control system 2 comprises, for example, a communication unit 16 (FIG. 5) for transmitting the instructions B to the HMI-unit 17.

For example, the control system 2 (e.g., communication unit 16) transmits instructions B to the HMI-unit 17 to output a question to the driver if the driver is willing to drive to a perceived center line 18 of a lane 11. The question is, for example, output by the HMI-unit 17 by visual and/or audio notification. Further, the control system 2 (e.g., communication unit 16) receives an information C of the HMI-unit 17 corresponding to an answer of the driver. The information C (answer C) of the driver is, for example, “Yes”. The answer C can be input by the driver, for example, by touching a respective field of a touch panel, pushing a button, turning a knob, saying one or more words and/or making a gesture. Furthermore, the driver is then driving from an initial position P0 to a position P1 (FIG. 2). Next, the control system 2 (e.g., the communication unit 16) transmits instructions D to the HMI-unit 17 (FIG. 5) to prompt the driver to confirm that the driver has driven to the perceived center line 18 of the lane 11. The driver can then input an answer E as confirmation.

In a fourth step S4 of the method, the control system 2 (e.g., the detecting unit 15) detects a presence of one or more other vehicles 19, 20, 21 on the road 10 on which the vehicle 1 (ego-vehicle 1) is driving based on the sensor data S. The other vehicles 19, 20, 21 are, in particular, detected in a region of interest 22. In the shown example of FIG. 2, there is a preceding vehicle 19 on the same lane 11 as the ego-vehicle 1 present. Further, there is a vehicle 20 on a left neighboring lane 12 and a vehicle 21 on a right neighboring lane 13 present.

The control system 2 (e.g., the detecting unit 15) determines, for example, positional data of each of the vehicles 19, 20, 21 with respect to the position P1 of the ego-vehicle 1 based on the sensor data S.

In a fifth step S5 of the method, the control system 2 determines a virtual lane 23 (FIG. 3) based on the perceived center line 18 to which the driver has driven and based on the positional data determined for the vehicles 19, 20, 21. The control system 2 comprises, for example, a determining unit 24 (FIG. 5) for determining the virtual lane 23.

Firstly, the control system 2 searches for a suitable target vehicle 19 preceding the ego-vehicle 1. In particular, after the driver has driven to the perceived center line 18 (FIG. 2), the control system 2 determines a driving channel T of the ego-vehicle 1. A length L of the driving channel T corresponds to a driving distance of the ego-vehicle 1 in a predetermined time span. The predetermined time span is, for example, included in a range of 0.5 to 2 seconds, 0.8 to 1.2 seconds and/or is equal to or below 1 second. The length L is determined based on the predetermined time span and a measured speed of the ego-vehicle 1. The speed is measured based on sensor data S (e.g., wheel speed sensor data) of the sensor system 3 of the ego-vehicle 1. A width W_{D} of the driving channel T corresponds to a predetermined vehicle width W_{V} of the ego-vehicle 1. The width W_{D} of the driving channel T is, for example, equal to the predetermined vehicle width W_{V} or is slightly larger (e.g., 10%, 20% or 30% larger) as the predetermined vehicle width W_{V}. The region of interest 22 includes the driving channel T at least partially.

Further, the control system 2 determines a percentage of an overlap O between the determined driving channel T and the preceding vehicle 19. In the shown example of FIG. 2, the percentage of the overlap O between the determined driving channel T and the preceding vehicle 19 is 100%. If the determined percentage of the overlap O is above a predetermined value (e.g., 30%), it is determined that the preceding vehicle 19 is driving on the same lane 11 as the ego-vehicle 1. The vehicle 19 shown in FIG. 2 is, thus, classified as preceding target vehicle 19 suitable for lane keeping purposes.

In a different example, in which a percentage of the overlap O is equal to or below the predetermined value (e.g., 30%) and above a further predetermined value (e.g., 10%), the driver is prompted to reposition the ego-vehicle 1. Next, the above-described suitability test by determining the overlap O is repeated. Then, the vehicle 19 is either classified as preceding target vehicle 19 suitable for lane keeping purposes or it is determined that the preceding vehicle 19 is unsuitable for determining the virtual lane 23.

Secondly, the control system 2 searches for suitable left and/or right target vehicles 20, 21. In particular, the control system 2 determines a lateral distance M_{L}, M_{R} (FIG. 3) between each of the vehicles 20, 21 detected in the region of interest 22 and the ego-vehicle 1 based on the sensor data S. The lateral distance M_{L}, M_{R} includes a left lateral distance M_{L} with respect to a left side 25 of the ego-vehicle 1 and a right lateral distance M_{R} with respect to a right side 26 of the ego-vehicle 1.

Next, the control system 2 determines that a respective other vehicle 20 is driving on a left neighboring lane 12 (left target vehicle 20) with respect to the ego-vehicle 1, when the determined left lateral distance ML between the ego-vehicle 1 and the respective vehicle 20 is above a predetermined threshold. Further, the control system 2 determines that a respective other vehicle 21 is driving on a right neighboring lane 13 with respect to the ego-vehicle 1 (right target vehicle 21), when the determined right lateral distance M_{R} between the ego-vehicle 1 and the respective vehicle 21 is above the predetermined threshold. Thus, the vehicle 20 shown in FIG. 3 is classified as a left target vehicle 20 suitable for lane keeping purposes, and the vehicle 21 shown in FIG. 3 is classified as a right target vehicle 21 suitable for lane keeping purposes.

Hence, in the shown example of FIGS. 2 and 3, there are three suitable target vehicles 19, 20, 21 such that the virtual lane 23 can be determined advantageously based on the positional data of the three target vehicles 19, 20, 21.

Next, the virtual lane 23 is determined, for example, by determining a left delineation 35 (FIG. 3) of the virtual lane 23 based on the positional information M_{L}, 31 of the left target vehicles 20 and/or determining a right delineation 36 of the virtual lane 23 based on the positional information M_{R}, 32 of the right target vehicles 21. For example, the left delineation 35 of the virtual lane 23 is determined such that a lateral distance M_{T} between the driving channel T and the left delineation 35 is larger than a predetermined lateral threshold. Further, the right delineation 36 of the virtual lane 23 is determined such that a distance M_{T} between the driving channel T and the right delineation 36 is larger than the predetermined lateral threshold. If both a left and right target vehicle 20, 21 are present, the lane keeping function of the ego-vehicle 1 can be performed such that the ego-vehicle 1 is driving laterally (in the middle or not in the middle) between the left and right target vehicles 20, 21.

Furthermore, for example, a first preliminary center line 27 (FIG. 3) is derived based on the detected preceding target vehicle 19 and a second preliminary center line 28 is derived based on the detected left and right target vehicles 20, 21. Then, a center line 29 of the virtual lane 23 is determined based on the first and second preliminary center lines 27, 28. In the shown example of FIGS. 2 and 3, a symmetric situation is illustrated in which the first preliminary center line 27 and the second preliminary center line 28 are identical. However, in other (more realistic) situations, the first and second preliminary center lines 27, 28 may not be identical. In such a non-symmetric situation, the center line 29 of the virtual lane 23 may be determined based on a mean value or weighted mean value of the first and second preliminary center lines 27, 28.

The first preliminary center line 27 of the virtual lane 23 is, for example, determined based on a lateral distance M1 (FIG. 4) between the preceding target vehicle 19 and the ego-vehicle 1 and/or based on a trajectory 30 (FIG. 3) of the preceding target vehicle 19. It is noted that in FIG. 3, a situation is shown in which a lateral distance between the preceding target vehicle 19 and the ego-vehicle 1 is zero, while in FIG. 4 a situation is shown in which the lateral distance M1 between the preceding target vehicle 19 and the ego-vehicle 1 is greater than zero.

Further, the second preliminary center line 28 of the virtual lane 23 is, for example, determined such that a lateral distance M2 (FIG. 4) between the second preliminary center line 28 and the left target vehicle 20 equals a lateral distance M3 between the second preliminary center line 28 and the right target vehicle 21. In other words, the second preliminary center line 28 is a middle line between trajectories 31, 32 of the left and right target vehicles 20, 21.

In a case in which only one of the left and right target vehicles 20, 21 is present, the second preliminary center line 28 may also be determined such that a lateral distance M_{L}, M_{R} (FIG. 3) between the ego-vehicle 1 and the respective left or right target vehicle 20, 21 is equal to or above a predetermined safety distance M_{S}.

As illustrated in FIG. 3, a lane width W_{L} of the virtual lane 23 is determined such that it equals a sum of the predetermined vehicle width W_{V}, a left offset value O1 (left lateral offset value) and a right offset value O2 (right lateral offset value). If a left target vehicle 20 has been detected, the left offset value O1 is, for example, determined based on the determined lateral distance M_{L} between the ego-vehicle 1 and the left target vehicle 20 (e.g., O1=½ M_{L}). If no suitable target vehicle has been detected on the left lane 12, the left offset value O1 is set equal to a predetermined value. Further, if a right target vehicle 21 has been detected, the right offset value O2 is, for example, determined based on the determined lateral distance M_{R} between the ego-vehicle 1 and the right target vehicle 21 (e.g., O2=½ M_{R}). If no suitable target vehicle has been detected on the right lane 13, the right offset value O2 is set equal to a predetermined value.

In step S6 of the method, the control system 2 performs a lane keeping assistant function to keep the ego-vehicle 1 on the determined virtual lane 23. The control system 2 comprises, for example, a lane keeping unit 33 (FIG. 5) for performing the lane keeping assistant function. The control system 2 further comprises, for example, an output unit 34 (FIG. 5) for outputting instructions A to a steering system (not shown) of the ego-vehicle 1 to steer the ego-vehicle towards the center line 29 of the determined virtual lane 23.

Further, if a preceding target vehicle 19 is detected, an adaptive cruise control based on the detected preceding target vehicle 19 may be performed such that a longitudinal distance N (FIG. 4) between the ego-vehicle 1 and the preceding target vehicle 19 is controlled to have a predetermined distance value.

If only a preceding target vehicle 19 but no left and/or right target vehicles 20, 21 are detected and if the preceding target vehicle 19 begins to steer away, for example, performs a lane change, the control system 2 may detect that the preceding target vehicle 21 steers away, for example, based on a determined lateral speed of the preceding target vehicle 19 being above a predetermined speed threshold. In this case, the control system 2 may relinquish determining the virtual lane 23 based on the preceding target vehicle 19 and send instructions to the HMI-unit 17 to notify the driver, for example by means of a visual and/or audio notification. When the ego-vehicle 1 is approaching a newly preceding vehicle (not shown), the control system 2 may determine if the newly preceding vehicle is suitable as preceding target vehicle (determine percentage of overlap O) and determine the virtual lane 23 based on positional data of the newly preceding vehicle.

Further, if left and/or right target vehicles 20, 21 are detected, a cruise control based on the detected left and/or right target vehicles 20, 21 may be performed such that a speed of the ego-vehicle 1 is controlled based on a speed of the left and/or right target vehicles 20, 21.

To summarize, although there are no lane markings on the road 10 available (FIG. 2), a lane keeping assistant function can still be provided by the control system 2 by determining a virtual lane 23 (FIG. 3). In particular, the virtual lane 23 is derived based on a driver of the vehicle 1 driving to a perceived center line 18 of a lane 11 (FIG. 2). Thus, the driver who might be in a better position to perceive and understand the overall scenario is providing feedback to the control system 2 where the correct lane 11 might be located. Furthermore, the virtual lane 23 may, in addition to the driver's feedback, also be determined based on positional data M₁, M_{L}, M_{R}, 30, 31, 32 of other vehicles 19, 20, 21 in the region of interest 22 (FIG. 2). Hence, lane keeping functionality can be improved.

Although the present invention has been described in accordance with preferred embodiments, it is obvious for the person skilled in the art that modifications are possible in all embodiments.

### LIST OF REFERENCE SIGNS

1 vehicle
2 control system
3 sensor system
4 sensor unit
5 sensor unit
6 sensor unit
7 sensor unit
8 surrounding
9 windscreen
10 road
11 lane
12 lane
13 lane
14 receiving unit
15 detecting unit
16 communication unit
17 HMI-unit
18 center line
19 vehicle
20 vehicle
21 vehicle
22 region of interest
23 virtual lane
24 determining unit
25 left side
26 right side
27 first preliminary center line
28 second preliminary center line
29 center line
30 trajectory
31 trajectory
32 trajectory
33 lane keeping unit
34 output unit
35 delineation
36 delineation
A instructions
B instructions
C information (answer)
D instructions
E answer
L length
M1 lateral distance
M2 lateral distance
M3 lateral distance
M_{L} lateral distance
M_{R} lateral distance
M_{S} safety distance
M_{T} safety distance
N longitudinal distance
O overlap
O1 left offset value
O2 right offset value
P0 position
P1 position
S1-S6 method steps
T driving channel
W_{D} width
W_{L} width
W_{V} width

1. A method for operating an ego-vehicle,
the method comprising:
receiving sensor data of a sensor system of the ego-vehicle,
detecting an absence of lane markings based on the sensor data,
transmitting instructions to a human machine interface of the ego-vehicle vehicle to prompt a driver of the ego-vehicle to drive to a perceived center line of a lane,
determining a virtual lane based on the perceived center line to which the driver has driven, and
performing a lane keeping assistant function to keep the ego-vehicle on the virtual lane.

2. The method according to claim 1,
further comprising detecting a presence of one or more other vehicles in a region of interest based on the sensor data,
wherein the virtual lane is determined based on positional information of the one or more other vehicles with respect to the ego-vehicle,
wherein the positional information is determined based on the sensor data.

3. The method according to claim 2,
further comprising:
determining, after the driver has driven to the perceived center line, a driving channel of the ego-vehicle based on the sensor data,
wherein a length of the driving channel corresponds to a driving distance of the ego-vehicle in a predetermined time span, a width of the driving channel corresponds to a predetermined vehicle width, and the region of interest includes the driving region at least partly,
determining a percentage of an overlap between the determined driving channel and a vehicle detected in the region of interest and preceding the ego-vehicle,
determining that the preceding vehicle is driving on the same lane as the ego-vehicle and is a preceding target vehicle when the determined percentage of the overlap is above a predetermined value, and
determining the virtual lane based on the positional information of the preceding target vehicle.

4. The method according to claim 3,
wherein, when it is determined that the percentage of the overlap is equal to or below the predetermined value and above a further predetermined value, transmitting instructions, determining a percentage of overlap between the determined driving channel and a vehicle, determining that the preceding vehicle is driving in the same lane as the ego-vehicle, and determining the virtual lane, are repeated,
wherein the further predetermined value is smaller than the predetermined value, and
wherein, when it is determined that the percentage of the overlap is equal to or below the further predetermined value, it is determined that the preceding vehicle is unsuitable for determining the virtual lane.

5. The method according to claim 2,
further comprising:
determining a lateral distance between each of the one or more other vehicles detected in the region of interest and the ego-vehicle based on the sensor data,
wherein the lateral distance includes a left lateral distance with respect to a left side of the ego-vehicle and a right lateral distance with respect to a right side of the ego-vehicle,
determining that a respective other vehicle is driving on a left neighboring lane with respect to the ego-vehicle and is a left target vehicle, when the determined left lateral distance thereof is above a predetermined threshold, and determining that a respective other vehicle is driving on a right neighboring lane with respect to the ego-vehicle and is a right target vehicle, when the determined right lateral distance thereof is above the predetermined threshold; and
determining the virtual lane based on the positional information of the left or right target vehicles on the left or right neighboring lanes.

6. The method according to claim 5,
wherein determining the virtual lane includes determining a left or right delineation of the virtual lane based on the positional information of the left target vehicle or right target vehicle respectively.

7. The method according to claim 2,
wherein a center line of the virtual lane is determined based on a first preliminary center line or a second preliminary center line,
wherein the first preliminary center line is derived based on a detected preceding target vehicle, and
wherein the second preliminary center line is derived based on detected left or right target vehicles.

8. The method according to claim 7,
wherein the center line of the virtual lane is determined based on a mean or weighted mean value of the first preliminary center line and the second preliminary center line.

9. The method according to claim 7,
wherein, when a preceding target vehicle is detected, the first preliminary center line of the virtual lane is determined based on a lateral distance between the preceding target vehicle and the ego-vehicle,
wherein, when a left target vehicle and a right target vehicle are detected, the second preliminary center line of the virtual lane is determined such that a lateral distance between the second preliminary center line and the left target vehicle equals a lateral distance between the second preliminary center line and the right target vehicle or
wherein, when a left target vehicle or a right target vehicle are detected, the second preliminary center line of the virtual lane is determined such that a lateral distance between the ego-vehicle and the left or right target vehicle is above a predetermined safety distance.

10. The method according to claim 7,
wherein a lane width of the virtual lane is determined such that the lane width equals a sum of the predetermined vehicle width, a left offset value and a right offset value, and
wherein the left offset value is determined based on the determined lateral distance between the ego-vehicle and the left target vehicle, or the left offset value is set equal to a predetermined value, or
wherein the right offset value is determined based on the determined lateral distance between the ego-vehicle and the right target vehicle, or
wherein the right offset value is set equal to a predetermined value.

11. The method according to claim 1, wherein transmitting instructions to a human machine interface includes:
transmitting instructions to the human machine interface to output a question to the driver if the driver is willing to drive to a perceived center line of a lane,
receiving an information of the human machine interface corresponding to an answer of the driver, and
transmitting, when the received information corresponds to a positive answer, instructions to the human machine interface to prompt the driver to confirm that the driver has driven to the perceived center line of the lane.

12. The method according to claim 1, further comprising:
performing an adaptive cruise control based on a detected preceding target vehicle such that a longitudinal distance between the ego-vehicle and the preceding target vehicle is controlled to have a predetermined distance value, or
performing a cruise control based on detected left and/or right target vehicles such that a speed of the ego-vehicle is controlled based on a speed of the left or right target vehicles.

13. A non-transitory computer readable medium comprising program instructions which, when executed by a computer, cause the computer to carry out the method according to claim 1.

14. A control system for a vehicle which is configured to perform the method according to claim 1.

15. A vehicle comprising a control system according to claim 14.
